(19) United States
(12) Patent Application Publication
(10) Pub. No.: US 2025/0214000 A1
(43) Pub. Date: Jul. 3, 2025

(54) METHOD AND SYSTEM FOR EXTRACTION OF CANNABINOIDS

(71) Applicant: Nakatomi Trading, LLC, Portland, OR (US)

(72) Inventors: JOHN NAITO, PORTLAND, OR (US); KYLER BUCK, PORTLAND, OR (US)

(21) Appl. No.: 18/402,540

(22) Filed: Jan. 2, 2024

(51) Int. Cl. B01D 11/02

(52) U.S. Cl. CPC B01D 11/0292

(57) ABSTRACT

A method includes adding an inert gas to a cannabinoid extraction system, mixing a solvent with plant matter having one or more desired compounds to form a mixture, recovering the solvent from the mixture, leaving a residual liquid, and pumping the inert gas to change pressures within the system to aid in the movement of at least one of the solvent, plant extracts, and desired compounds, without removing the inert gas from the system.

### BACKGROUND

Some methods for the extraction and purification of cannabinoids from biomass require many discrete separation processes using multiple solvents. In conventional techniques, crude oil is extracted from biomass with concentrations of the target cannabinoid as low as 50%.

Some processes use LPG, liquid petroleum gas, but moving the materials from each of the vessels used in the process can present issues.

### BRIEF DESCRIPTION OF THE DRAWINGS

FIG. 1 shows an embodiment of an extraction system using an inert gas for pressure management.

FIG. 2 shows a flow of materials in an embodiment of an extraction system using an inert gas for pressure management.

FIG. 3 shows another flow of materials in an embodiment of an extraction system using an inert gas for pressure management.

FIG. 4 shows another flow of materials in an embodiment of an extraction system using an inert gas for pressure management.

### DETAILED DESCRIPTION

The embodiments here generally involve the extraction and purification of cannabinoids using a hydrocarbon solvent, such as liquified petroleum gas (LPG). LPG may comprise butane, propane, or a mix of the two, and may include other hydrocarbons. A hydrocarbon solvent extraction generally achieves a high enough purity in the solution of crude oil and extraction solvent to create a supersaturation of the target cannabinoid. The cannabinoids may include, but are not limited to, cannabidiol (CBD), but could also apply to cannabidiol acid (CBDA), cannabigerol (CBG), cannabinol (CBN), tetrahydrocannabinol (THC), tetrahydrocannabinol acid (THCA) etc., and their variations.

The embodiments involve a method that may include the use of an inert gas into the flow of the system to manage the pressure to allow easier movement of materials between vessels. This discussion uses some specific terms. The term “extraction vessel” as used here means the vessel in the process that receives the plant extract and the solvent, referred to here as the “mixture.” Similarly, the term “solvent evaporator” means a vessel to which the mixture is moved and in which the solvent is separated from the mixture leaving the extract behind to be collected. Other embodiments could use mechanisms other than evaporation to separate the solvent from the extract.

Generally, the embodiments involve adding an inert gas to a cannabinoid extraction system, mixing a solvent with plant extracts having one or more desired compounds to form a mixture. The desired compounds may include, but are not limited to, cannabinoids and terpenes, The process then separates the solvent from the mixture, leaving a residual liquid composed of the desired compounds., and extracting the desired compounds from the residual liquid. The process pumps the inert gas to change pressures within the system to aid in the movement of at least one of the solvent, plant extracts, terpenes, and cannabinoids, without removing the inert gas from the system. The below process sets out specific processes and vessels, with the understanding that these specifics merely aid in understanding of the embodiments and are not intended to limit the scope of the claims.

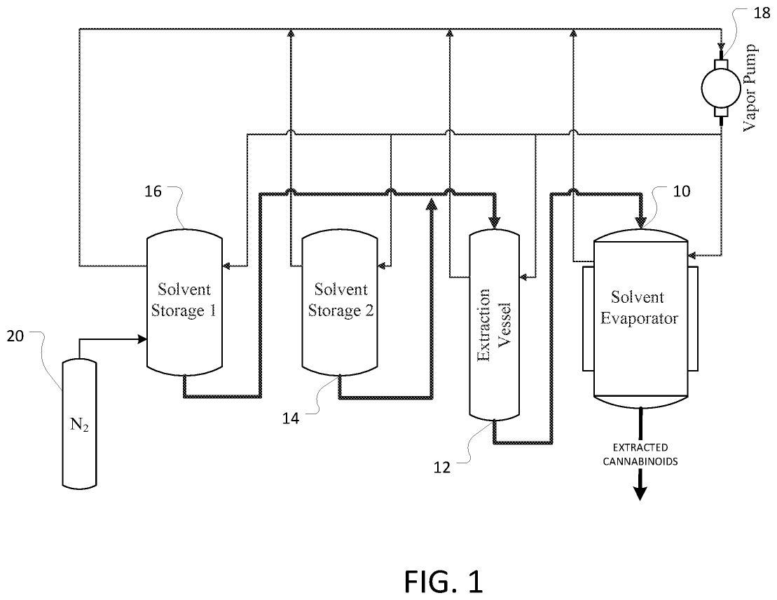

FIG. 1 shows an overall view of the material movement process to allow extraction of cannabinoids with the material flow path shown by the heavier lines. The method combines cannabis plant matter, and a solvent into the extraction vessel 12. The solvent may reside in one or more solvent storage vessels or tanks such as 16 and 14, and the method moves them into the extraction vessel. The extraction vessel may have controllable process conditions including the solvent composition, temperature, and agitation. Controlling the process conditions may increase the extraction of target compounds and decrease the extraction of impurities. The control of process conditions may differ between the extraction vessel and the solvent evaporator.

In one embodiment, the solvent may comprise a hydrocarbon solvent. Hydrocarbon solvents include, but are not limited to, propane, hexane, heptane, and butane. Some hydrocarbon solvents have high toxicity, making them inappropriate for use in extraction. In one embodiment, the solvent is propane. Others in the industry use butane, or more typically, a mix of butane with other solvents including propane. These solvents, either together or separately, may take the form of liquid petroleum gas (LPG).

Once an acceptable amount of cannabinoids and terpenes have dissolved in the solvent, the system moves the mixture to the solvent evaporator 10. The recipe under which the system operates determines the acceptable amount of the desired compounds, and the details of which lie outside the subject matter of this patent. Once the mixture reaches the solvent evaporator, the solvent evaporator 10 heats the mixture to evaporate the solvent and allows for extraction of the cannabinoids. One should note that the solvent evaporator of the figures represents only one example of a solvent separator. The process may use any solvent separator, such as the evaporator shown, a filter, or other means.

An issue arises in moving the mixture from one vessel to another using vapor pumps, such as 18. To assist with moving the mixture and other materials more efficiently around the system, the embodiments introduce nitrogen or other inert gas to the system. The following discussion uses nitrogen with the understanding that they may use other inert gases including argon, helium, radon, or neon. In one embodiment, an inert gas, in this case nitrogen, supply 20 could connect to one of the various vessels in the system to introduce nitrogen into the system. The supply could be disconnected or just left attached to the system, but it will not interact with the system otherwise. As will be discussed in more detail, the process may pump the inert gas back to supply 20.

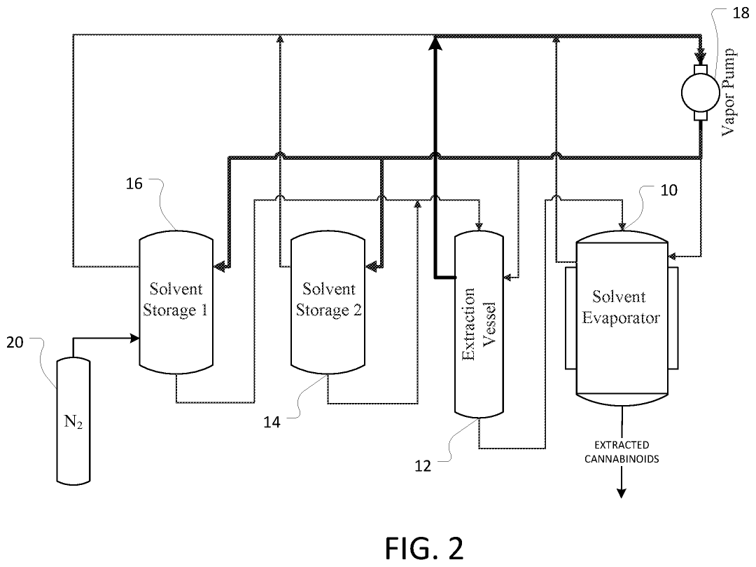

FIG. 2 shows a second flow diagram. In this embodiment, the system pumps the nitrogen from the extraction vessel 12 to the solvent storage vessel or vessels 14 and 16. The nitrogen pumps from the extraction vessel 12 through the vapor pump to the storage vessel or vessels 14 and 16. This causes the liquid solvent to move from storage vessels 14 and 16 to extraction vessel 12. The heavier line in FIG. 2 represents the nitrogen flow.

One should note that the embodiments discussed here employ two solvent storage vessels 14 and 16 but may employ one or more storage vessels. One should not take the reference to “vessels” to mean any particular number of vessels, including a single vessel.

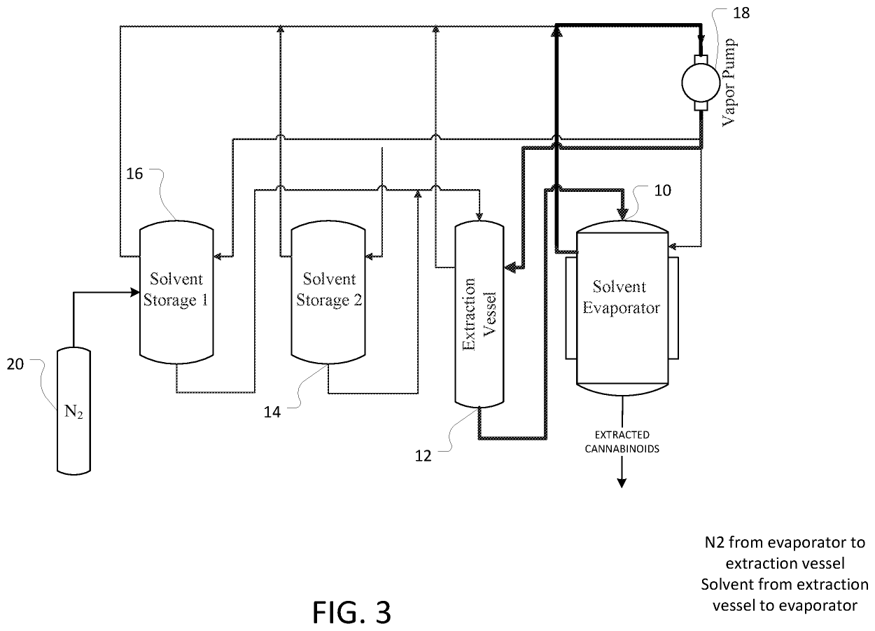

FIG. 3 shows a different embodiment of a flow. The nitrogen flows from the solvent evaporator 10 through pump 18 to the extraction vessel 12. This causes the solvent to move from the extraction vessel 12 to the evaporator 10.

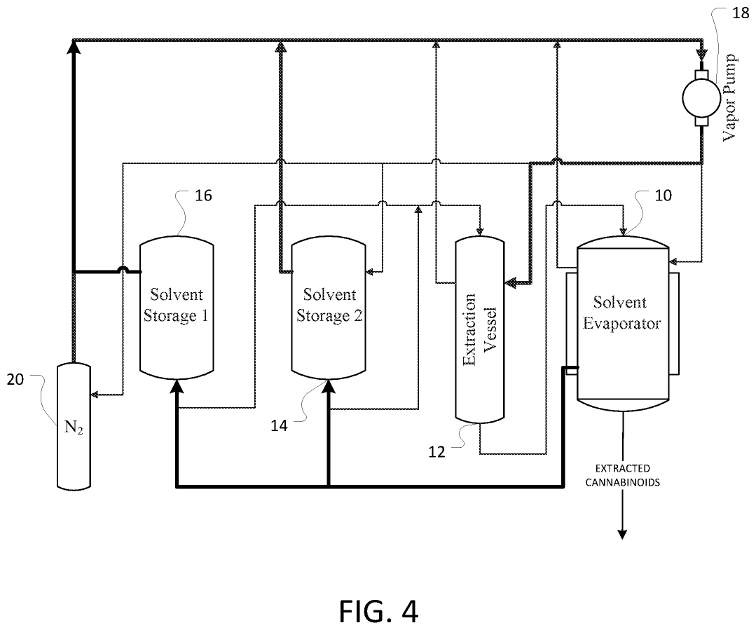

FIG. 4 shows a different embodiment of a flow and another embodiment of the nitrogen supply. In this embodiment, the system pumps the nitrogen from the solvent storage vessels 14 and 16 to the vapor pump 18. The nitrogen then pumps into the extraction vessel 12. This causes the solvent to move from the extraction vessel 12 to the solvent evaporator. This embodiment uses additional piping from the evaporator 10 to the solvent storage vessels 14 and 16 so that evaporated solvent can return to the solvent storage vessels. In one embodiment, the evaporated solvent is condensed through a heat exchanger and returns to the solvent storage vessel as a liquid.

FIG. 4 shows an alternative embodiment of the nitrogen supply. In this embodiment, the nitrogen supply 20 remains connected to the system as an additional accumulator or pressure vessel to which nitrogen can be pumped and from which nitrogen can be pulled. This particular aspect of the embodiments applies to all the embodiments, not just the one of FIG. 4.

Additionally, this written description makes reference to particular features. It is to be understood that the disclosure in this specification includes all possible combinations of those particular features. For example, where a particular feature is disclosed in the context of a particular aspect, that feature can also be used, to the extent possible, in the context of other aspects.

Also, when reference is made in this application to a method having two or more defined steps or operations, the defined steps or operations can be carried out in any order or simultaneously, unless the context excludes those possibilities.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although specific aspects of the disclosure have been illustrated and described for purposes of illustration, it will be understood that various modifications may be made without departing from the spirit and scope of the disclosure. Accordingly, the disclosure should not be limited except as by the appended claims.

What is claimed is:

1. A method, comprising;
adding an inert gas to a cannabinoid extraction system;
mixing a solvent with plant matter having one or more desired compounds to form a mixture;
recovering the solvent from the mixture, leaving a residual liquid; and
pumping the inert gas to change pressures within the system to aid in the movement of at least one of the solvent, plant extracts, and desired compounds, without removing the inert gas from the system.

2. The method as claimed in claim 1, wherein adding an inert gas comprises adding one of nitrogen, argon, helium, radon, or neon to the system.

3. The method as claimed in claim 1, further comprising mixing the solvent with plant extracts in an extraction vessel.

4. The method as claimed in claim 1, wherein recovering the solvent comprises moving the mixture to a solvent separator, comprising one of either a solvent evaporator or filter.

5. The method as claimed in claim 3, wherein pumping the inert gas comprises pumping the inert gas from the extraction vessel to a solvent storage vessel to cause the solvent to move from the solvent storage vessel to the extraction vessel.

6. The method as claimed in claim 3, wherein pumping the inert gas comprises pumping the inert gas from a solvent separator to the extraction vessel to move the solvent from the extraction vessel to the solvent separator.

7. The method as claimed in claim 1, wherein pumping the inert gas comprises pumping the inert gas from a solvent storage vessel to the extraction vessel to move the solvent from the extraction vessel to a solvent separator.

8. The method as claimed in claim 1, wherein adding the inert gas comprises adding the inert gas to the system from an inert gas supply such that the inert gas supply has no interaction with the system after adding the inert gas.

9. The method as claimed in claim 1, wherein adding the inert gas comprises using a separate gas vessel to allow the gas to be pulled from the separate gas vessel and pumped to the separate gas vessel.

10. The method as claimed in claim 1, wherein removing the solvent from the mixture comprises heating the mixture to cause the solvent to evaporate.
